(19) United States
(12) Patent Application Publication
(10) Pub. No.: US 2024/0176310 A1
(43) Pub. Date: May 30, 2024

(54) MACHINE CONTROLLER AND METHOD FOR CONFIGURING THE MACHINE CONTROLLER

(71) Applicant: Siemens Aktiengesellschaft, München (DE)

(72) Inventors: Theodoros Papadopoulos, München (DE); Felix Köhler, München (DE); Dirk Hartmann, Aßling (DE)

(21) Appl. No.: 18/552,514

(22) PCT Filed: Mar. 17, 2022
(86) PCT No.: PCT/EP2022/057081

§ 371 Date: Sep. 26, 2023

(30) Foreign Application Priority Data
Apr. 1, 2021 (EP) 21166569.0

(51) Int. Cl. G05B 13/02

(52) U.S. Cl. CPC G05B 13/0265

(57) ABSTRACT

To configure a machine controller for a machine, a plurality of state signals of a first state space is read in, each state signal being assigned an optimized control signal. Using the state signals, a first signal converter is trained to convert state signals from the first state space into a second state space which is dimension-reduced in comparison with the first state space. A second signal converter is trained to reproduce corresponding optimized control signals by converting reduced state signals by means of the conversion rule. Thus, the machine controller is designed to convert a state signal of the machine into a reduced state signal by means of the trained first signal converter and to convert the reduced state signal into an optimized control signal by means of the trained second signal converter, the optimized control signal being used to control the machine.

### CROSS-REFERENCE TO RELATED APPLICATIONS

This application claims priority to PCT Application No. PCT/EP2022/057081, having a filing date of Mar. 17, 2022, which claims priority to EP Application No. 21166569.0, having a filing date of Apr. 1, 2021, the entire contents both of which are hereby incorporated by reference.

### FIELD OF TECHNOLOGY

The following relates to a machine controller and a method for configuring the machine controller.

### BACKGROUND

So-called model predictive controls are often used to control complex machines, such as robots, manufacturing plants, gas turbines, wind turbines, internal combustion engines, building technology plants or infrastructure technology plants. These are often also referred to as model predictive control or MPC. In an MPC controller, a future behavior of a machine to be controlled is simulated depending on the input variables in order to determine, on the basis thereof, an output signal that optimizes this behavior. However, performing a suitable simulation requires significant computing resources in many cases, especially for real-time applications with short response times.

It is well known to perform a large number of simulations for a variety of different operating conditions in advance to reduce computational requirements, and to use the simulation results to derive explicit rules that supplement or replace simulative control. However, deriving such rules often requires a great deal of manual effort.

Alternatively or additionally, simulations can be used to train a data-driven machine learning model, which then complements or replaces the simulative control. However, a control characteristic conveyed by a trained machine learning model is usually analytically intractable or difficult to interpret for a user. This can be particularly problematic if such a controller requires certification.

### SUMMARY

An aspect relates to provide a machine controller for controlling a machine, and a method for configuring the machine controller to allow efficient or more flexible control of the machine.

In order to configure a machine controller for a machine, a plurality of state signals is read in, each specifying a state of the machine in a first state space, and each of which is assigned a control signal optimized for the respective state. In particular, the machine can be a robot, an engine, a manufacturing plant, a gas turbine, a wind turbine, an internal combustion engine, a building technology plant, an infrastructure technology plant or one of the components thereof. A first signal converter is trained, based on the plurality of state signals, to convert state signals from the first state space into a second state space, which is dimensionally reduced in comparison thereto, to form reduced state signals, wherein information loss is minimized. Minimizing is also understood here and in the following as an approximation to a minimum. Accordingly, optimization here and in the following is also understood as an approximation to an optimum. Furthermore, a second signal converter is trained, by composing a conversion rule from discrete rule elements, to reproduce corresponding optimized control signals by converting reduced state signals using the conversion rule. Thus, the machine controller is configured to convert a state signal from the machine using the trained first signal converter into a reduced state signal and to convert this using the trained second signal converter into an optimized control signal, by means of which the machine is controlled.

A machine controller, a computer program product (non-transitory computer readable storage medium having instructions, which when executed by a processor, perform actions) and a non-volatile computer-readable storage medium are provided for executing the method according to embodiments of the invention.

The method according to embodiments of the invention as well as the machine controller according to embodiments of the invention can be executed or implemented, for example, by means of one or more computers, processors, application-specific integrated circuits (ASIC), digital signal processors (DSP) and/or so-called field programmable gate arrays (FPGA).

Embodiments of the invention allow an explicit conversion rule to be generated for a dimensionally reduced state space, by means of which a machine can be controlled in an optimized way. Such a conversion rule, in contrast to data-driven machine learning models, can in many cases be interpreted, comprehended, and/or evaluated with respect to its consequences by a user, especially as a heuristic rule. In many cases, this enables flexible analysis, further development and/or certification of a machine controller configured in this way.

According to an advantageous embodiment of the invention, a behavior of the machine can be simulated for a variety of operating scenarios. Thus, a control signal can be determined for a respective simulated state of the machine, which optimizes a simulated behavior of the machine induced thereby, in particular according to predetermined criteria. The determined control signal can then be assigned to the corresponding state signal as an optimized control signal. Advantageously, the operating scenarios can include a variety of operating conditions and/or operating states of the machine. The operating scenarios can be extracted in particular from the operating data of the machine or from a database. Alternatively or additionally, the operating scenarios can be generated synthetically, in particular randomly. In order to optimize a respective state-specific control signal, a machine behavior induced by this can be simulated respectively for several variants of the control signal. Depending on this, the variant that leads to a particularly advantageous behavior of the machine can then be selected as the optimized control signal. If necessary, a respective optimized control signal can also be generated by means of an interpolation of several advantageous control signal variants.

According to another advantageous embodiment of the invention, the state signals may be linearly converted from the first state space to the second state space by the first signal converter. The linear conversion can be carried out in particular by means of a transformation matrix. Here, a vector representing a respective state signal can be multiplied by the transformation matrix to obtain a vector representing a reduced state signal. For training the first signal converter, the matrix elements of the transformation matrix and, if necessary, its number of rows can be optimized as parameters in such a way that the information loss is minimized. For effective dimensionality reduction, the transformation matrix should have many more columns than rows. However, since a reduction in the number of rows is usually accompanied by an increase in the information loss, the number of rows can additionally be optimized during optimization in such a way that the information loss still remains acceptable according to a given criterion. For example, as a criterion, it can be specified that a reproduction error of the second signal converter does not exceed a specified threshold.

A principal component analysis can be performed on the plurality of state signals to train the first signal converter. This allows the first signal converter to be configured to map state signals onto the found principal components of the state signals. In this way, both matrix elements of a transformation matrix and its number of rows can be optimized. This kind of principal component analysis is often also referred to as PCA. Efficient standard numerical methods, such as singular value decomposition methods, are available for performing principal component analysis.

According to a further advantageous embodiment of the invention, a respective state signal can be evaluated together with the respective associated optimized control signal during the principal component analysis. This proves to be advantageous in many cases, since correlations between state signals and control signals can also be detected in this way and used for dimensionality reduction. Such correlations are common, insofar as a specific control signal causes a specific sequence of states in many cases. Advantageously, a transformation matrix can be extended by additional columns for multiplication by a vector representing a control signal. After performing the joint principal component analysis, the additional columns of the resulting transformation matrix can then be removed again.

According to a particularly advantageous embodiment of the invention, the discrete rule elements may comprise numerical operators. Symbolic regression with the numerical operators can then be performed to train the second signal converter. The numerical operators can each be encoded by a specific operator identifier, in particular by an operator symbol. Operators may include, in particular, addition, subtraction, multiplication, division, exponentiation, sine function, cosine function, or other discrete mathematical or numerical operations. By means of symbolic regression, the operators can be combined to form an expression, in particular a mathematical expression, in such a way that a conversion of a reduced state signal based thereon reproduces a corresponding optimized control signal as accurately as possible.

Alternatively or in addition to symbolic regression, polynomial regression can also be performed to train the second signal converter. A so-called ridge polynomial approximation can be used here, which proves to be very advantageous in many cases, especially when combining dimensionality reduction and polynomial regression.

Furthermore, for training the second signal converter, different sequences of numerical operators can be generated and the reduced state signals can be converted into output signals according to a respective sequence. A sequence can be determined in which a distance of the output signals from the corresponding optimized control signals is minimized. The conversion rule can then be formed based on the determined sequence. In particular, a respective sequence of numerical operators can be represented, encoded, or specified as a graph, an expression tree, or a symbolic mathematical expression. In such a form, an operator sequence or a resulting conversion rule is usually particularly easily interpretable for a user and thus can be further used in a flexible way.

In particular, a genetic optimization method can be used to train the second signal converter. By means of such genetic optimization methods, many optimization tasks, especially discrete ones, can be solved efficiently. In the present case, the composition of the discrete rule elements can be efficiently solved as a discrete optimization task. A variety of implementations are available for performing a genetic optimization method.

According to an advantageous further development of embodiments of the invention, operating condition-specific state signals and/or operating condition-specific optimized control signals can be read in respectively for different operating conditions of the machine. An operating condition can refer to an operating scenario, a constraint to be met, a limit value to be met and/or an operating restriction. An operating condition-specific second signal converter can then be trained for each of the different operating conditions on the basis of the respective operating condition-specific state signals and/or operating condition-specific optimized control signals. An operating condition of the machine can then be detected and, depending on this, one of the operating condition-specific second signal converters can be selected to control the machine. In this way, several second signal converters optimized for different operating conditions can be kept on hand and used specifically depending on a current operating condition.

According to another advantageous embodiment of the invention, a machine learning module may be trained to generate synthetic reduced state signals based on reduced state signals. The synthetic reduced state signals can then be additionally used to train the second signal converter. In this way, the training of the second signal converter can usually be accelerated considerably. Moreover, in many cases, any influence of statistical outliers in the training data is reduced.

### BRIEF DESCRIPTION

Some of the embodiments will be described in detail, with reference to the following figures, wherein like designations denote like members, wherein:

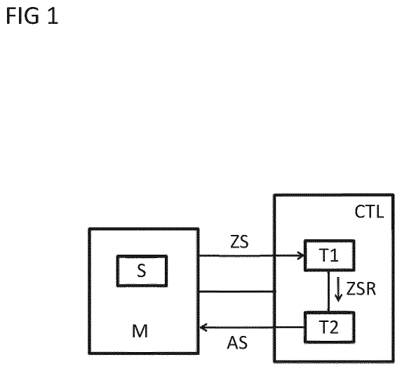

FIG. 1 shows a manufacturing robot with a machine controller according to the invention;

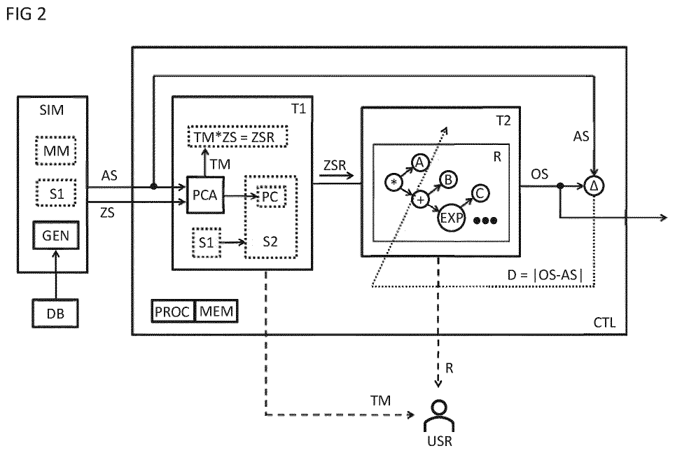

FIG. 2 shows a machine controller according to the invention in a training phase;

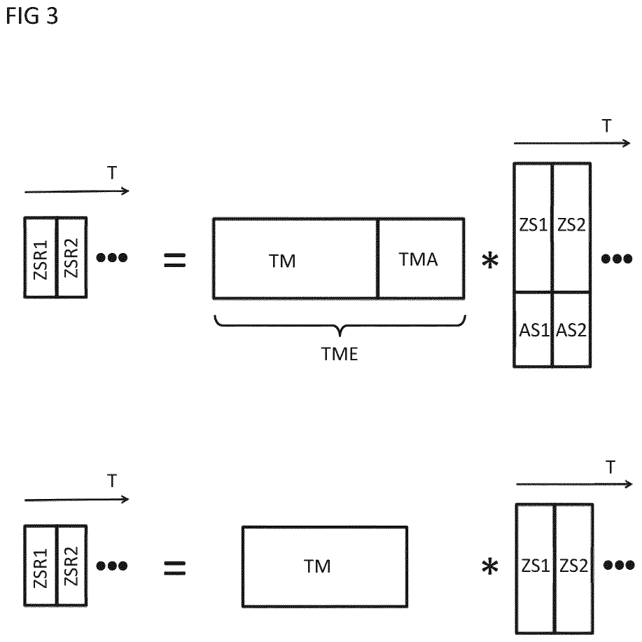

FIG. 3 shows a conversion of a state signal from a first state space to a dimensionally reduced, second state space; and

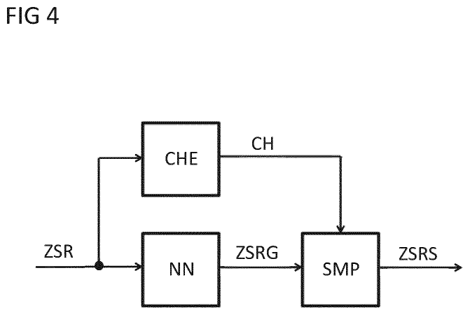

FIG. 4 shows a generation of synthetic reduced state signals.

### DETAILED DESCRIPTION

FIG. 1 shows an exemplary manufacturing robot as a machine M to be controlled. To control the manufacturing robot M, it is coupled to a machine controller CTL according to embodiments of the invention. Alternatively or in addition to the manufacturing robot, the machine M to be controlled may also be a robot, a manufacturing plant, an engine, a gas turbine, a wind turbine, an internal combustion engine, a building technology plant, an infrastructure technology plant, a motor vehicle or another machine.

The machine controller CTL can be implemented as part of the manufacturing robot M or completely or partially external to the manufacturing robot M. In the present figures, the machine controller CTL is shown externally to the manufacturing robot M for reasons of clarity.

The machine controller CTL is used to control the manufacturing robot M and was trained for this purpose using machine learning methods. In this context, control is also understood to mean control of the manufacturing robot M as well as output or use of control-relevant data or signals, i.e. data or signals contributing to the control of the manufacturing robot M. Such control-relevant data or signals may include, in particular, control signals, prediction data, monitoring signals, state signals, and/or classification data that can be used, in particular, for operation optimization, monitoring, or maintenance of the manufacturing robot M and/or for wear or damage detection.

The manufacturing robot M has a sensor system S that continuously measures one or more operating parameters of the manufacturing robot M and outputs them in the form of measured values. The measured values of the sensor system S and any otherwise recorded operating parameters of the manufacturing robot M are transmitted as state signals ZS from the manufacturing robot M to the machine controller CTL. By means of the state signals ZS, in particular one or more current states of the manufacturing robot M are indicated, specified or encoded, over the course of time. The state signals ZS specify time series of operating parameters, i.e. time sequences of values of operating parameters. The state signals ZS may comprise, in particular, physical, chemical, control, effect and/or design-related operating parameters, property data, performance data, effect data, behavior signals, system data, control data, control signals, sensor data, measured values, environmental data, monitoring data, prediction data, analysis data and/or other data arising during operation of the manufacturing robot M and/or describing an operating state or a control action of the manufacturing robot M. This can be, for example, positioning data, speed data, rotation data, temperature data, pressure data or data about acting or exerted forces, about a rotational speed, about emissions, about vibrations, about vibration states or about a resource consumption of the manufacturing robot M.

The state signals ZS are represented by numerical data vectors, each specifying a state of the manufacturing robot M in a typically high-dimensional, first state space. The first state space can have, for example, ten to several hundred dimensions. Based on the transmitted state signals ZS, the trained machine controller CTL determines control signals AS that optimize a performance of the manufacturing robot M. In particular, the performance to be optimized may concern precision, power, yield, speed, runtime, error rate, error extent, resource requirement, efficiency, pollutant emission, stability, wear, lifetime and/or other target parameters of the manufacturing robot M.

To generate suitable optimized control signals AS, the state signals ZS are first fed into a first signal converter T1 of the machine controller CTL. The first signal converter T1 converts the state signals ZS from the first state space into a dimensionally reduced, second state space to form reduced state signals ZSR. The second state space has considerably fewer dimensions than the first state space, for example 2 to 6. The conversion by the first signal converter T1 is optimized—as will be explained in more detail below—to minimize information loss during conversion.

The reduced state signal ZSR is fed from the first signal converter T1 to a second signal converter T2 coupled thereto. The second signal converter T2 is explicitly rule-based and converts the reduced state signals ZSR into optimized control signals AS by means of a conversion rule composed in an optimized manner.

The optimized control signals AS are transmitted from the second signal converter T2 to the manufacturing robot M in order to control this in an optimized manner. Such a control signal AS can be used, for example, to position a robot arm of the manufacturing robot M or to control a rotational speed of an axis in an optimized manner.

FIG. 2 illustrates a machine controller CTL according to embodiments of the invention in a training phase. The training is intended to enable the machine controller CTL to control a machine M—as described above—in an optimized manner. The machine controller CTL is thus configured by the training.

Insofar as the same or corresponding reference signs are used in the figures, these reference signs designate the same or corresponding entities, which may in particular be implemented or designed as described in connection with a respective figure.

The machine controller CTL comprises one or more processors PROC for executing the method according to embodiments of the invention and one or more memory modules MEM for storing method data.

For training, the machine controller CTL is coupled to a simulator SIM for simulating the manufacturing robot M or one or more of its components. The simulator SIM serves the purpose of simulatively generating a plurality of state signals ZS and associated optimized control signals AS of the manufacturing robot M as training data for training the machine controller CTL. As already mentioned above, the state signals ZS each specify one or more states of the manufacturing robot M over the course of time. The state signals ZS can be represented as numerical data vectors in a first state space S1 mapped by the simulation. Accordingly, the optimized control signals can be represented as data vectors in a control action space mapped by the simulation.

In particular, the simulation is intended to determine, for a state of the manufacturing robot M specified by a respective state signal ZS, the control signal that optimizes a behavior of the manufacturing robot M induced by the control signal according to a predetermined criterion. This control signal is then assigned to the relevant state signal ZS as optimized control signal AS.

For the aforementioned purpose, the simulator SIM simulates a behavior of the manufacturing robot M for a variety of operating scenarios. The latter may include a variety of operating conditions and/or operating states that may occur during operation of the manufacturing robot M. Such operating scenarios can be extracted in particular from operating data of the manufacturing robot M and/or from a database DB. In the present embodiment, a plurality of operating scenarios and operating states of the manufacturing robot M are generated by a generator GEN of the simulator SIM. The generator GEN generates state signals, trajectories, time series, external influences, operating events and/or constraints to be met that may occur during operation of the manufacturing robot M. To vary the generated operating scenarios, the generation can also be random. The generation of the operating scenarios is based on framework data or model data for the manufacturing robot M, which are stored in the database DB and fed into the generator GEN for the purpose of generation.

To simulate the behavior of the manufacturing robot M in a respective generated operating scenario, the simulator SIM has a simulation model MM of the manufacturing robot M. In particular, the simulation model MM can model geometric, physical, and effect properties of the manufacturing robot M. For the efficient physical simulation of a machine, here M, by means of a simulation model, here MM, a variety of efficient methods are available, such as so-called finite element methods or multibody simulation methods.

As already mentioned above, the simulator SIM respectively simulates a behavior of the manufacturing robot M resulting from the application of a respective control action for a plurality of possible states of the manufacturing robot M as well as for a plurality of possible control actions. The respective simulated behaviors are then evaluated by the simulator SIM with respect to their performance and the control signal AS that optimizes this performance is determined. The performance-optimizing control signal AS is then assigned to the relevant state signal ZS.

The state signals ZS are fed as training data from the simulator SIM into the machine controller CTL with their respective assigned optimized control signal AS. Alternatively or additionally, the state signals ZS and the optimized control signals AS can also be fed into the machine controller CTL by the manufacturing robot M itself, by a manufacturing robot similar to it, or by a database.

The machine controller CTL is trained using the training data ZS and AS. In this context, training is generally understood as optimization of a mapping from input signals to output signals. This mapping is optimized according to predefined and/or learned criteria during a training phase. Criteria that can be used here include, for example, a prediction error or reproduction error in the case of prediction models, a classification error in the case of classification models, a deviation from an optimized control action in the case of control models, and/or minimization of information loss in the case of conversion models. Training enables, for example, model parameters, method parameters, interconnection structures of neurons of a neural network and/or weights of connections between the neurons to be adjusted or optimized in such a way that the criteria are fulfilled as well as possible. The training can thus be seen as an optimization problem. A variety of efficient optimization methods are available for such optimization problems. In particular, genetic optimization methods, gradient descent methods, principal component analysis methods, and/or particle swarm optimization methods can be used.

According to embodiments of the invention, the machine controller CTL has a first signal converter T1 and a second signal converter T2, which are to be trained using the training data ZS and AS.

In the present embodiment, the first signal converter T1 is trained to determine a transformation matrix TM that maps a respective state signal ZS onto a reduced state signal ZSR, from the first state space S1 into a second state space S2, which is dimensionally reduced in comparison. In doing so, any information loss that occurs should be minimized. As already mentioned above, the second state space S2 has a considerably smaller dimension than the first state space S1.

The mapping of a respective state signal ZS onto the associated reduced state signal ZSR is performed by matrix multiplication of a vector representing the respective state signal ZS in the first state space S1 by the transformation matrix TM. The result of this multiplication is then a vector representing the associated reduced state signal ZSR in the second state space S2. That is, ZSR=TM*ZS, wherein to simplify the notation the representing vectors have been designated with the same reference signs as the represented state signals ZS and ZSR, respectively.

The matrix elements of the transformation matrix TM and, if necessary, its number of rows are optimized in such a way that any information loss occurring during the transformation is minimized. This can be done, for example, by determining an information loss respectively for a plurality of transformations for variations of the matrix elements, and in this way determining a set of matrix elements that minimizes the information loss. As a measure of information loss, it is possible to determine, for example, how well the original state signals ZS can be reproduced from reduced state signals ZSR. In the present embodiment, the transformation matrix TM is determined by a principal component analysis PCA. A variety of standard numerical methods, for example singular value decomposition, are available for performing such principal component analysis.

For principal component analysis PCA, the first signal converter T1 is supplied with the state signals ZS and the associated optimized control signals AS. The principal component analysis PCA is advantageously performed jointly for the state signals ZS and the control signals AS. For this purpose, the transformation matrix TM is extended by additional columns for multiplication by a vector representing a control signal.

A conversion of state signals ZS and possibly associated optimized control signals AS by the transformation matrix TM or an extended transformation matrix TME is illustrated in FIG. 3. The upper part of FIG. 3 illustrates a conversion by a transformation matrix TME extended by additional columns TMA, as is used for the principal component analysis PCA. Here ZS1, ZS2, . . . each represent a vector representing a state signal and AS1, AS2, . . . each represent a vector representing a control signal over the course of time T. According to the extension of the transformation matrix TM by the additional columns TMA, the vectors ZS1, ZS2, . . . are each supplemented by an associated vector AS1 or AS2, . . . to form an extended vector, which now jointly represents a state signal and its associated control signal. The extended vectors (ZS1, AS2), (ZS2, AS2), . . . are each multiplied by the extended transformation matrix TME to obtain a reduced state vector ZSR1 or ZSR2, . . . as the result of each of the matrix multiplications. The vectors ZS1, ZS2, . . . are thereby in a sense multiplied by the non-extended transformation matrix TM and the vectors AS1, AS2, . . . are multiplied by the additional columns TMA.

As already mentioned above, the principal component analysis PCA is performed for the extended transformation matrix TME. In the extended transformation matrix TME determined by the principal component analysis PCA, the extended columns TMA are then removed again, leaving only the transformation matrix TM. The resulting transformation matrix TM is then used for multiplication by non-extended state vectors ZS1, ZS2, . . . in order to transform from the first state space S1 into the reduced, second state space S2 as intended. This conversion by the transformation matrix TM is illustrated in the lower part of FIG. 3.

Using the trained transformation matrix TM, state signals ZS are mapped onto their principal components PC found by the principal component analysis PCA. The principal components PC in a sense span the second state space S2.

The principal component analysis PCA of state signals ZS together with their associated optimized control signals AS is advantageous in that correlations between state signals ZS and control signals AS can also be detected in this way and used for efficient dimensionality reduction.

As FIG. 2 further illustrates, the reduced state signals ZSR obtained by converting the state signals ZS by means of the transformation matrix TM are transmitted from the first signal converter T1 to a second signal converter T2 of the machine controller CTL. Insofar as an optimized control signal AS is assigned to a respective state signal ZS, said control signal is also assigned to the reduced control signal ZSR converted from this state signal ZS.

The second signal converter T2 shall be trained to convert reduced state signals into optimized control signals by means of an explicit conversion rule R. For this purpose, a plurality of reduced state signals ZSR are each converted in accordance with the conversion rule R, and a resulting output signal OS of the second signal converter T2 is compared in each case with the assigned optimized control signal AS. The conversion rule R is then optimized or parameterized to minimize a distance D between the output signals OS and the respective assigned optimized control signals AS.

The conversion rule R is composed of discrete rule elements during the training of the second signal converter T2, which in the present embodiment comprise in particular numerical operators. For example, addition, subtraction, multiplication, division, exponentiation, a sine function and/or a cosine function can be used as numerical operators. The operators are each encoded by a specific operator identifier, a common operator symbol. In FIG. 2 some exemplary operators are marked by the operator symbols +, * and EXP. The operators act on operands A, B and C.

In the present embodiment, the conversion rule R comprises one or more sequences of numerical operators, structured as a so-called expression tree or algorithmic tree. Such an expression tree is formed by a tree-linked data structure of coded operators, operands, and possibly numeric parameters. The operators act in the linking direction on operands or on results of linked operations. A symbolic mathematical expression or an explicit symbolic formula is encoded by an expression tree. In particular, an expression tree with multiple operands can be conceived as a multivariate function.

In the present embodiment, the conversion of the second signal converter T2 is determined by the expression tree of the conversion rule R. The conversion rule R thus forms a generally nonlinear multivariate function, which is numerically evaluated by the second signal converter T2.

The conversion rule R maps a respective vector representing a reduced state signal ZSR in the second state space S2 onto an output signal OS in the control action space according to R(ZSR)=OS. Together with the conversion by the first signal converter T1 the result is therefore OS=R(TM*ZS). To simplify the notation, no distinction has been made here between the representing vectors and the represented quantities.

Symbolic regression is performed for the expression tree to optimize the conversion rule R. Said expression tree is varied with the aim of finding a conversion rule R that converts a reduced state signal ZSR into the most advantageous control signals possible. For this purpose, a large number of different sequences of operators and operands are generated, if necessary with different parameterizations. As already indicated above, for each sequence, the output signals OS generated by applying the sequence to the reduced state signals ZSR are compared with the optimized control signal AS associated with a respective reduced state signal ZSR. A distance D between the respective output signal OS and the corresponding optimized control signal AS is determined, for example according to D=|OS−AS| or D=(OS−AS)². The distance D—as indicated by a dotted arrow in FIG. 2—is fed back to the second signal converter T2 in order to select or optimize an operator sequence there that minimizes the distance D. A genetic optimization method is used for minimization. A variety of efficient implementations are available for such genetic optimization methods.

By optimizing the conversion rule R, the second signal converter T2 is trained to reproduce the optimized control signals AS as accurately as possible. In many cases, the optimized control signals AS can be reproduced with an accuracy of 1% or less. After successful training, the output signals OS of the second signal converter T2 can thus be output as optimized control signals and used for optimized control of the manufacturing robot M.

The series connection of the first signal converter T1 and the second signal converter T2 forms a so-called machine learning pipeline. The first signal converter T1 and the second signal converter T2 and thus the machine controller CTL are trained and configured by the training. The two signal converters T1 and T2 can be trained together.

The transformation matrix TM optimized by the training as well as the conversion rule R optimized by the training can advantageously be output by the first signal converter T1 and the second signal converter T2, respectively, to a user USR of the machine controller CTL. Both the transformation matrix TM and the conversion rule R are easily interpretable by the user USR due to their explicit representation. In particular, the conversion rule R forms an explicit heuristic control rule that is analytically tractable, certifiable, and evolvable. This represents a considerable advantage over data-driven models such as neural networks, whose transformations are usually analytically intractable.

For a fast adaptation of the machine controller CTL to different operating conditions of the manufacturing robot M, a plurality of operating condition-specific second signal converters T2 can be provided, which are trained for a respective operating condition in an operating condition-specific manner. Then, as soon as a current operating condition for the manufacturing robot M is detected or acquired, a second signal converter T2 specifically trained for this current operating condition can be selected.

Furthermore, training the second signal converter T2 can often be improved by additionally generating a plurality of synthetic reduced state signals and using them for training. Such a generation of synthetic reduced state signals ZSRS is illustrated in FIG. 4.

For the purpose of this generation, a machine learning module NN, for example a neural network, is trained on the basis of a plurality of reduced state signals ZSR to generate synthetic reduced state signals ZSRG that are as similar as possible to reduced state signals ZSR according to predetermined criteria and/or have a similar statistical distribution. To generate new variants of reduced state signals, the machine learning module NM can be excited, especially by random signals. A variety of well-known methods are available for training such a machine learning module NM.

The reduced state data ZSR used to train the machine learning module NN are also fed into an extractor CHE, which determines and extracts a convex hull CH of the reduced state data in the second state space.

The synthetic reduced state signals ZSRG generated by the machine learning module NN and the convex hull CH are fed into a sampling device SMP. The synthetic reduced state signals ZSRG are sampled by the sampling device SMP using interpolation within the complex hull CH on a preferentially equidistant grid of the state space S2. The sampled synthetic reduced state signals ZSRS are then output by the sampling device SMP and used as additional reduced state signals for training the second signal converter T2.

By increasing the amount of training data as well as sampling these equidistantly, effects of statistical outliers are minimized in an efficient manner. Moreover, a hypersurface of the reduced state data ZSR in the second state space S2 is effectively smoothed. It turns out that in this way the training of the second signal converter S2 can be significantly accelerated in many cases.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for configuring a machine controller for a machine, the method comprising:
a) reading in a plurality of state signals, each specifying a state of the machine in a first state space, and each of which is assigned a control signal optimized for the respective state;
b) training a first signal converter, based on the plurality of state signals, to convert the plurality of state signals from the first state space into a second state space, which is dimensionally reduced in comparison thereto, to form reduced state signals, wherein information loss is minimized;
c) training a second signal converter, by composing a conversion rule from discrete rule elements, to reproduce corresponding optimized control signals by converting reduced state signals using the conversion rule; and
d) converting by the machine controller, a state signal from the machine using the trained first signal converter into a reduced state signal and to convert the reduced state signal using the trained second signal converter into an optimized control signal, by means of which the machine is controlled.

2. The method as claimed in claim 1, wherein a behavior of the machine is simulated for a variety of operating scenarios, further wherein a control signal is determined for a respective simulated state of the machine which optimizes a simulated behavior of the machine induced thereby, and in that the determined control signal is assigned to the corresponding state signal as an optimized control signal.

3. The method as claimed in claim 1, wherein the plurality of state signals and/or associated optimized control signals are read in from the machine, from a machine similar thereto, from a simulation of the machine and/or from a database.

4. The method as claimed in claim 1, where the plurality of state signals are linearly converted from the first state space into the second state space by the first signal converter.

5. The method as claimed in claim 1, wherein a principal component analysis is performed on the plurality of state signals for training the first signal converter, and
wherein the first signal converter is configured for mapping the plurality of state signals onto the found principal components of the plurality of state signals.

6. The method as claimed in claim 5, wherein a respective state signal is evaluated together with the respectively assigned optimized control signal during the principal component analysis.

7. The method as claimed in claim 1, wherein the discrete rule elements comprise numerical operators, and symbolic regression with the numerical operators is performed to train the second signal converter.

8. The method as claimed in claim 1, wherein the discrete rule elements comprise numerical operators, and for training the second signal converter:
different sequences of the numerical operators are generated,
the reduced state signals are converted into output signals according to a respective sequence,
a sequence is determined in which a distance of the output signals from the corresponding optimized control signals is minimized, and
the conversion rule is formed based on the determined sequence.

9. The method as claimed in claim 1, wherein a genetic optimization method is used to train the second signal converter.

10. The method as claimed in claim 1, wherein operating condition-specific state signals and/or operating condition-specific optimized control signals are read in for different operating conditions of the machine,
wherein an operating condition-specific second signal converter is trained for each of the different operating conditions on the basis of the respective operating condition-specific state signals and/or operating condition-specific optimized control signals,
wherein an operating condition of the machine is detected, and
wherein one of the operating condition-specific second signal converters is selected to control the machine as a function of the operating condition detected.

11. The method as claimed in claim 1, wherein a machine learning module is trained to generate synthetic reduced state signals based on reduced state signals, and
wherein the generated synthetic reduced state signals are additionally used for training the second signal converter.

12. A machine controller for controlling a machine, configured for executing the method as claimed in claim 1.

13. A computer program product comprising a computer readable hardware storage device having computer readable program code stored therein, said program ode executable process of a computer system to implement a method as claimed in claim 1.

14. A computer-readable storage medium comprising the computer program product as claimed in claim 13.
